(19) United States
(12) Patent Application Publication
(10) Pub. No.: US 2010/0135291 A1
(43) Pub. Date: Jun. 3, 2010

(54) IN-BAND SIGNALLING FOR POINT-POINT PACKET PROTECTION SWITCHING

(75) Inventors: David MARTIN, Stittsville (CA); Marc HOLNESS, Nepean (CA); Bernard ST-DENIS, Ottawa (CA)

Correspondence Address: BLAKE, CASSELS & GRAYDON, LLP, 45 O'CONNOR ST., 20TH FLOOR, OTTAWA, ON, K1P 1A4, CA

(73) Assignee: NORTEL NETWORKS LIMITED, St. Laurent (CA)

(21) Appl. No.: 12/626,975

(22) Filed: Nov. 30, 2009

Related U.S. Application Data
(60) Provisional application No. 61/118,554, filed on Nov. 28, 2008.

(51) Int. Cl. H04L 12/56

(52) U.S. Cl. 370/389

(57) ABSTRACT

A method of controlling traffic forwarding in a Provider Backbone-Traffic Engineered (PBB-TE) network. A protection group (PG) is defined, and including N working Traffic Engineered Service Instances (TESIs) and M protection TESIs. An Automatic Protection Switching Protocol Data Unit (APS PDU) is defined, which includes information defining at least a state of the protection group. This APS PDU is forwarded only through the protection TESI(s).

### CROSS-REFERENCE TO RELATED APPLICATIONS

This application is based on, and claims benefit of, provisional U.S. patent application No. 61/118,554, which was filed Nov. 28, 2009, the entire contents of which are hereby incorporated herein by reference.

### MICROFICHE APPENDIX

Not Applicable.

### TECHNICAL FIELD

The present invention relates to management of traffic forwarding in packet networks, and in particular to in-band signalling for point-point packet protection switching.

### BACKGROUND OF THE INVENTION

Network operators and carriers are deploying packet-switched communications networks in place of circuit-switched networks. In packet-switched networks such as Internet Protocol (IP) networks, IP packets are routed according to routing state stored at each IP router in the network. Similarly, in Ethernet networks, Ethernet frames are forwarded according to forwarding state stored at each Ethernet switch in the network. The present invention applies to communications networks employing any Protocol Data Unit (PDU) based network and in this document, the terms “packet” and “packet-switched network”, “routing”, “frame” and “frame-based network”, “forwarding” and cognate terms are intended to cover any PDUs, communications networks using PDUs and the selective transmission of PDUs from network node to network node.

In Ethernet networks, Provider Backbone Transport (PBT), also known as Provider Backbone Bridging-Traffic Engineering (PBB-TE), as described in Applicant's British patent number GB 2422508 is used to provide a unicast (i.e. point-to-point—p2p) Ethernet transport technology. Provider Link State Bridging (PLSB) as described in Applicant's co-pending U.S. patent application Ser. No. 11/537,775 can be used to provide a transport capability for Ethernet networks using IS-IS to set up unicast paths in the network. Both above patent documents are hereby incorporated by reference.

Provider Link State Bridging (PLSB) typically uses protocols such as Intermediate System—Intermediate System (IS-IS) or Open Shortest Path First (OSPF) to exchange topology, addressing and service information to enable the calculation of paths for forwarding packets from any given source node to one or more destination nodes, and to install the forwarding state required to implement those paths. OSPF and IS-IS are run in a distributed manner across nodes of the network so that each node will locally compute paths based on the view of network topology shared by the routing system.

As is known in the art, IS-IS and OSPF are “routing” protocols, in which “Dijkstra” or similar algorithms are used to compute shortest paths between any two nodes in the network. Once computed, these shortest paths can then be used to derive unicast paths, and to determine the forwarding state that must be installed in each node in order to implemented the derived paths. Techniques such as Reverse Path Forwarding Check (RPFC) can be used to mitigate the effect of any loops that may form transiently during periods when multiple distributed peer nodes independently compute paths and install the forwarding state.

FIG. 1 is a simplified illustration of a protection group (PG) 2 set up in a PBB-TE network domain in accordance with IEEE 802.1Qay. In the simplified view of FIG. 1, only a one-way traffic flow, from a west Customer Edge (CE-1) 4 to an east Customer Edge (CE-2) 6 is shown. In a typical implementation, the mappings of FIG. 1 would be mirrored to support traffic flow in the opposite direction as well. As may be seen in FIG. 1, the protection group 2 consists of two diverse traffic engineered service instances (TESIs) 8 between an West Bridge 10 and a East Bridge 12. One of the two TESIs 8 is designated as the active TESI, and the other is designated as a “back-up” or “protection” TESI. The operational behaviour of the protection group is governed by a selective bridging function implemented in the West bridge 10, and a traffic merging function implemented in the East bridge 12.

For example, a packet to be sent from the west Client Edge (CE-1) 4 to the East Customer Edge (CE-2) 6 is encapsulated with the Source Address (C-SA) of the West Customer Edge 4, the Destination Address (C-DA) of the East Customer Edge 6, and the Service Instance identifier (I-SID) assigned by the network, and sent to the Customer Backbone Port (CBP) 14 of the West Bridge 10, which hosts the West Customer Edge (CE-1) 4. Within the West Bridge 10, the packet is encapsulated with the backbone Source Address (B-SA) of the West Bridge 10, the backbone Destination Address (B-DA) of the East bridge 12, and a Backbone VLAN Identifier (B-VID) assigned to the active TESI for East-bound traffic. Thus encapsulated, the packet can then be conveyed through the active TESI to the East Bridge 12, which strips the B-DA, B-SA, and B-VID information, and forwards the de-capsulated packet to the East Customer Edge (CE-2) 6 via the Customer Backbone Port (CBP) 16 which hosts the East customer edge (CE-2) 6.

In the illustration of FIG. 1, TESI-A 8a is the active TESI, so that the selective bridging function in the West bridge 10 encapsulates east-bound packets with B-VID-1, as may be seen in FIG. 1. In the event of a network failure (or a network operator protection switch request) that affects TESI-A, the selective bridging function can switch the east-bound packets to TESI-B 8b. When this occurs, the West bridge 10 will encapsulate east-bound packets with B-VID-3, which is the B-VID assigned to TESI-B for east-bound traffic. Once this protection switch occurs, east-bound packets will automatically be forwarded through TESI-B.

In the East bridge 12, a traffic merging function accepts packets received through either of the two TESIs 8, and routes them to the Customer Backbone Port (CBP) 16 which hosts the East Customer Edge (CE-2) 6. As a result, a protection switching function does not need to be implemented in the East bridge 12 for proper forwarding of east-bound traffic.

An arrangement in which a single working path is protected by a single back-up (or protection) path, as shown in FIG. 1, is known as a 1:1 protection scheme.

A limitation of IEEE 802.1 Qay is that it relies on out-of-band signalling, such as a network operator's Data Communications Network (DCN) for the coordination of network operator requested protection switching operations. In this respect, the term out-of-band refers to signalling that does not traverse the same path as the subscriber traffic. However, the use of out-of-band signalling for the coordination of operator requested protection switching increases the complexity of network management functions, and means that a mismatch between the protection mode and the state of one or more involved switches may be undetectable. In addition, IEEE 802.1 Qay only provides a 1:1 protection scheme. In some cases, it may be desirable to provide more complicated M:N protections schemes, wherein M is the number of protection (back-up) paths, and N is the number of working paths.

An automatic protection switching scheme for Ethernet VLAN networks is described in the ITU-T G.8031 standard. This technique utilizes an Automated Protection Switching Protocol Data Unit (APS PDU) for in-band signalling of protection state information. However, this technique is not readily applicable to the problem of protection switching of point-to-point connections (i.e., TESIs) in PBB-TE network domains. Furthermore, G.8031 does not support generalized M:N protection schemes with multiple or shared protection paths.

Techniques which overcome at least some of the above-noted issues remain highly desirable.

### SUMMARY OF THE INVENTION

Thus, an aspect of the present invention provides a method of controlling traffic forwarding in a Provider Backbone-Traffic Engineered (PBB-TE) network. A protection group (PG) is defined, and including N working Traffic Engineered Service Instances (TESIs) and M protection TESIs. An Automatic Protection Switching Protocol Data Unit (APS PDU) is defined, which includes information defining at least a state of the protection group. This APS PDU is forwarded only through the protection TESI(s).

### BRIEF DESCRIPTION OF THE DRAWINGS

Further features and advantages of the present invention will become apparent from the following detailed description, taken in combination with the appended drawings, in which:

FIG. 1 is a block diagram schematically illustrating operation of a protection group in a Provider Backbone-Traffic Engineering (PBB-TE) network domain, known from IEEE 802.1 Qay;

FIG. 2 schematically illustrates a first frame format of an APS PDU usable in embodiments of the present invention;

FIGS. 3a-3d are tables showing representative values of APS specific fields of the APS PDU of FIG. 2;

FIG. 4 is a table showing representative values of the Flags field of the APS PDU of FIG. 2;

FIG. 5 schematically illustrates a second frame format of an APS PDU usable in embodiments of the present invention;

It will be noted that throughout the appended drawings, like features are identified by like reference numerals.

### DETAILED DESCRIPTION OF PREFERRED EMBODIMENTS

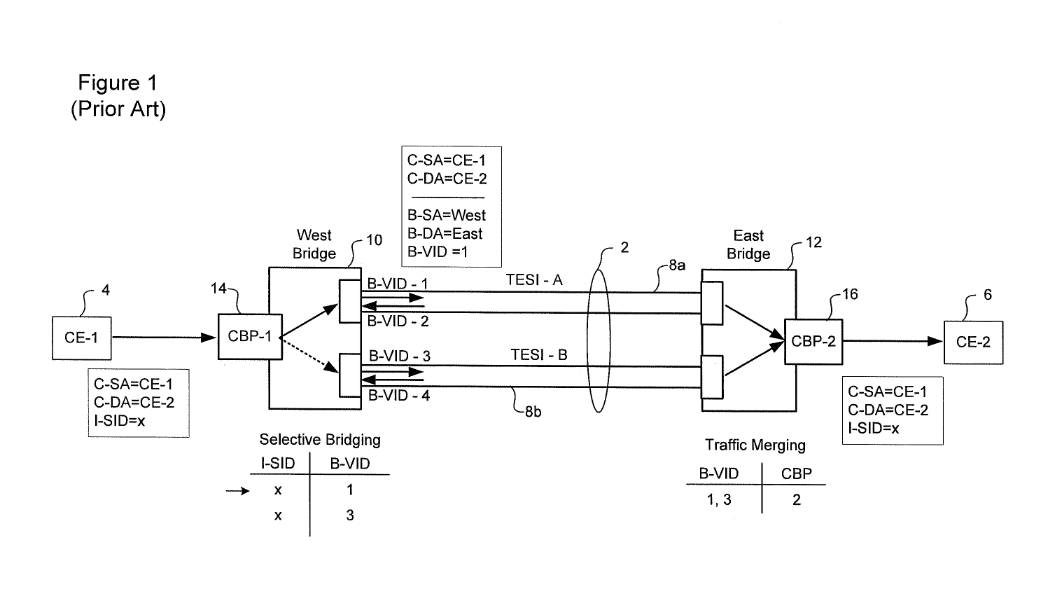

Embodiments of the invention are described below, by way of example only, with reference to FIGS. 1-5.

In very general terms, the present invention provides a method of controlling traffic forwarding in a Provider Backbone-Traffic Engineered (PBB-TE) network. A protection group (PG) is defined, and including N working Traffic Engineered Service Instances (TESIs) and M protection TESIs. An Automatic Protection Switching Protocol Data Unit (APS PDU) is defined, which includes information defining at least a state of the protection group. This APS PDU is forwarded only through the protection TESI(s).

Preferably, the present invention supports a generalized M:N protection scheme, in which N≧1 and M≧1. In the reduced case of N=1 and M=1, the protection scheme can be revertive or non-revertive, as desired. In a revertive protection scheme, traffic switched to the protection TESI in response to a Signal Failure (SF) or Forced Switch (FS) affecting the working TESI, is switched back to the working TESI following recovery from the failure (or removal of the FS). In a non-revertive protection scheme, the protection TESI to which traffic is switched in response to either a Signal Failure (SF) or Forced Switch (FS) is subsequently re-designated as a working TESI of the protection group.

Preferably, protection schemes in which either or both of N and M are greater than one are revertive.

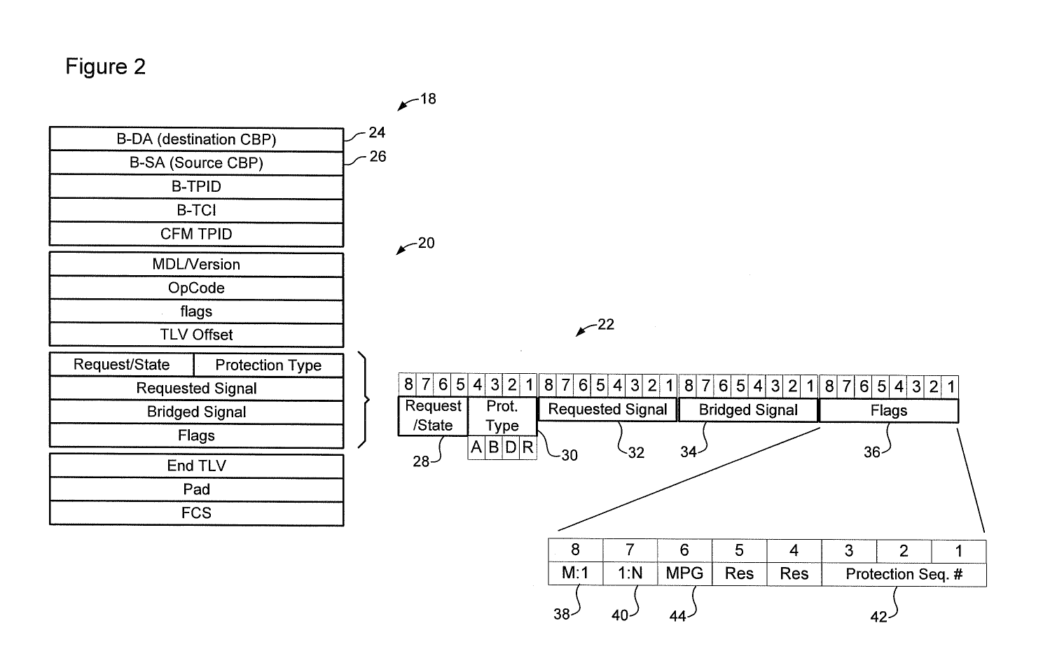

FIG. 2 schematically illustrates a representative APS PDU of a type which may be used in embodiments of the present invention. In the example of FIG. 2, the APS PDU frame format (i.e. frame size, field sizes etc.) generally follows that of an ITU-T G.8031 APS PDU. This is convenient because it enables the APS PDU of FIG. 2 to be handled by ITU-T G.8031 compliant Ethernet equipment. However, other frame formats may be used, as desired.

Referring to FIG. 2, the APS PDU is generally divided into a transport header 18, a common CFM header 20, and an APS block 22. The transport header 18 facilitates routing of the APS PDU though a point-to-point connection between end-point Customer Backbone Ports (CBPs) 14, 16. Thus, for example, the transport header includes a B-DA field 24 containing the address of the destination CBP, and a B-SA field 26 containing the address of the source CBP. This enables the APS PDU to be used for end-to-end continuity checks across the PBB-TE network domain, in conjunction with the CFM Continuity Check Message (CCM).

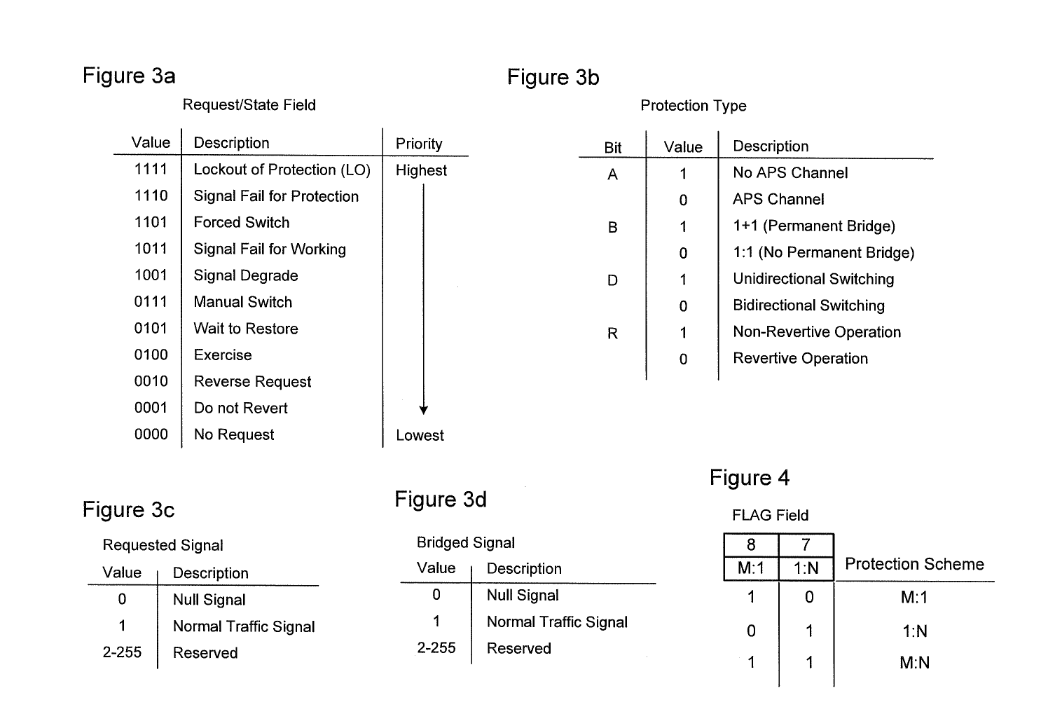

The APS block 22 is used to define the protection scheme and control protection switching behaviour of the protection group. In the embodiment of FIG. 2, the APS block 22 comprises a Request/State field 28; a Protection Type field 30; a Requested Signal field 32; a Bridged Signal field 34; and a Flags field 36. In some embodiments, each of the Request/State and Protection Type fields are four bits in length, while the Requested Signal, Bridged Signal and Flags fields are each one byte in length. Representative values which may be assigned to each of the Request/State, Protection Type, Requested Signal and Bridged Signal fields are shown in FIGS. 3a-3d. As may be appreciated, the field values shown in FIGS. 3a-3d follow the recommendations of ITU-T G.8031. Similarly, for the reduced case of a 1:1 protection scheme, these field values support protection switching behaviours in a PBB-TE network that are functionally equivalent to those set out in ITU-T G.8031. Accordingly, the meaning and use of these fields, and the conventional protection switching behaviours obtained thereby, will not be described in detail herein.

In some embodiments, when the working TESI is operating normally, the APS PDU is only sent through the protection TESI(s). This has the advantage of minimizing overhead traffic in the working TESI under normal operating conditions of the protection group. As may be appreciated, besides the use of CFM CCMs, continuity checks of a protection TEST can be performed by sending a “No-Request/Null/Null” APS PDU through the protection TESI at regular intervals. Referring to FIGS. 3a-3d, a “No-Request/Null/Null” APS PDU is an APS PDU in which the Request/State field is set to “0000” (No-request) and each of the Requested Signal and Bridged Signal fields are set to “0” (Null signal).

As noted above, the field value assignments shown in FIGS. 3a-d support protection switching behaviours in a PBB-TE network domain that are functionally equivalent to those set out in ITU-T G.8031. The Flags field 36 enables extension of this functionality to generalized M:N protection schemes, in which either one (or both) of N (the number of working TESIs) and M (the number of protection TESIs) is greater than one. Thus, for example, the specific protection scheme may be identified using the M:1 and 1:N bits 38,40 of the Flags field 36, as shown in FIG. 4.

The specific TESIs within a protection group, and their respective roles (i.e. “working” or “protection”) within the protection group, are determined at the time the protection group is set up. As a result, the specific protection scheme being implemented with the protection group is also known in advance. Accordingly, in some embodiments, the use of M:1 and 1:N bits 38,40 of the Flags field 36 (as shown in FIG. 4) may be omitted, and instead information identifying the protection scheme included in the protection group definition installed in each of the involved Customer Backbone Ports.

In some embodiments in which the number of protection TESIs M≧2, the protection TESIs may be arranged in a hierarchy, so that the protection switching function will switch traffic to each of the protection TESIs in a predetermined order. This operation may be accomplished using the protection sequence bits 42 of the Flags field 36. Thus, for example, a preferred protection TESI can be designated by setting the protection sequence bits to a value of “0” in APS PDUs sent through that protection TESI. A second (less preferred) protection TESI can be designated by setting the protection sequence bits to a value of “1” in APS PDUs sent through that protection TESI. Each of the other protection TESI's within the protection group can be similarly designated with a respective protection sequence number, in accordance with their position in the hierarchy. With this arrangement, the protection switching function will operate to switch traffic from the working TESI to each of the protection TESIs following the order of preference as defined by the protection sequence numbers. Thus, for example, traffic from the working TESI will be protection switched to a lower ranking protection TESI only if higher ranking protection TESI's are unable to accept the traffic.

In most cases, traffic can be successfully protection switched to a protection TESI if there is sufficient available capacity in that protection TESI.

In some embodiments, pre-emption rules may be defined to control the conditions under which traffic can be protection switched into a given protection TESI. This arrangement is useful in that it enables the protection TESIs to carry subscriber traffic during normal operations of the network, while still supporting effective protection of the working TESI.

In some embodiments, the pre-emption rules may be based on the customer-level service instance. Thus, for example, when a service instance is established, a desired Quality of Service (QoS) level can be selected and assigned to that service. If packets of that service must subsequently be protection switched to a protection TESI, the Customer Backbone Port can use the customer service instance identifier (I-SID) to control the protection switching behaviour. For example, working TESI traffic of a given QoS level may pre-empt protection TESI traffic having a lower QoS level.

In some embodiments, the pre-emption rules may be based on a priority of the protection switch request. For example, in FIG. 3a, the various Request/State field values are arranged in order of priority. Accordingly, the protection function may use the Request/State field priority level of the APS PDU to determine whether or not traffic can be protection switched into a given protection TESI. For example, in a case where the APS PDU of a given protection TESI has a Request/State field value of “1111” (Lockout), no traffic can be protection switched to that protection TESI.

Alternatively, consider a scenario in which a protection TESI is carrying traffic that has been switched from a working TESI due to a manual switch on that working TESI, In this case, the APS PDUs of the involved protection TESI will have a Request/State field value of “0111”. If a service failure affecting another working TESI occurs, an APS PDU with a Request/State field value of “1011” will be sent to the Customer Backbone Port to trigger the protection switch to the protection TESI. This protection switch request will be successful, and traffic within the protection TESI pre-empted as required, because the priority level of the received APS PDU is higher than that of the traffic already in the protection TESI. Conversely, if an exercise switch is requested (Request/State field value of “0100”), the request will be refused, because the priority level of the request APS PDU is lower than that of the traffic already in the protection TESI.

In some embodiments in which the number of working TESIs N≧2, a portion of a total capacity of a protection TESI may be allocated to each working TESI. With this arrangement, traffic from the working TESI may be protection switched to the protection TESI. However, the protection TESI may “throttle” the protection switched traffic in accordance with the amount of capacity allocated to that working TESI.

If desired, where the capacity of a protection TESI is partitioned between two or more working TESIs, each partition may have its own APS PDU. In this case, the Request/State field priority levels described above may be used to resolve contention issues between each of the working TESIs. For example, consider a scenario in which a protection TESI is carrying traffic that has been switched from a first working TESI due to a manual switch. In this case, traffic of the first working TESI will be allocated to a respective first partition of the protection TESI, and will have a corresponding APS PDU with a Request/State field value of “0111”. If a service failure affecting a second working TESI occurs, traffic of that working TESI can similarly be allocated to a respective second partition of the protection TESI, and will have a corresponding APS PDU with a Request/State field value of “1011”. A contention issue can arise if the total bandwidth requirement of the two traffic flows exceeds the capacity of the protection TESI. However, the respective Request/State field values of the two flows can be used to resolve contention, by allowing the traffic flow with the highest priority level to pre-empt lower priority traffic flows. In the above example, traffic in the second partition (which has a Request/State field value of “1011”) can pre-empt traffic of the first partition (which has a Request/State field value of “0111”)

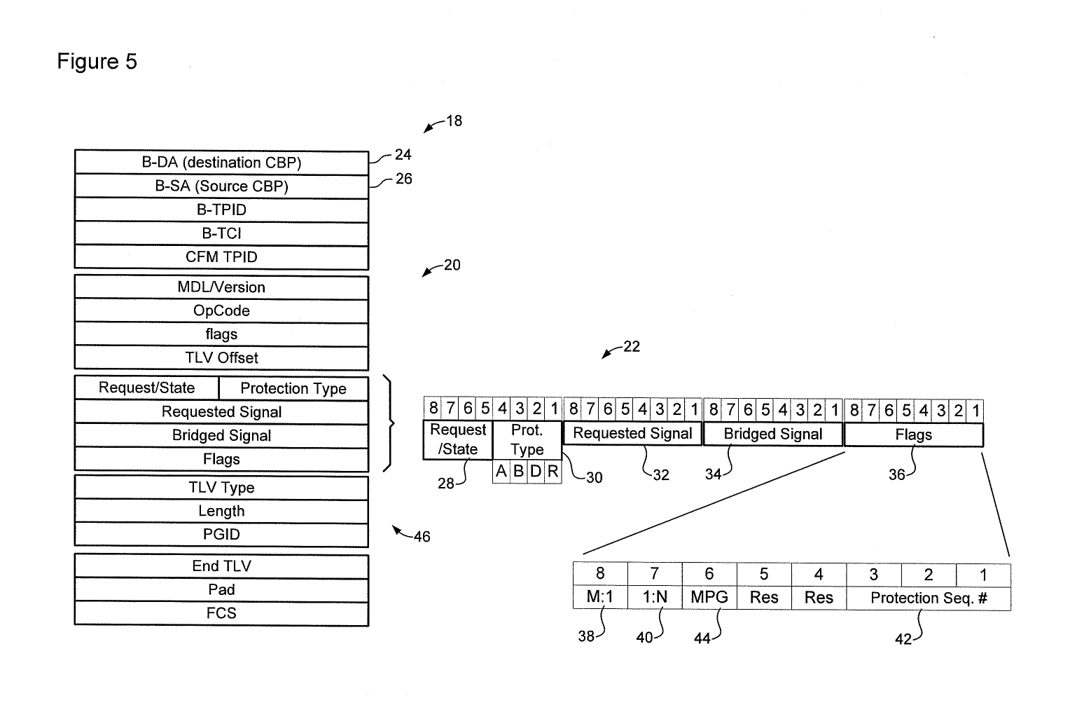

In some embodiments, a TESI may be shared between two or more protection groups. In such cases, the Multiple Protection Groups (MPG) bit 44 of the Flags field 36 can be set to indicate that the APS PDU contains a protection group block 46 (FIG. 5) which identifies the protection group to which the APS PDU belongs. With this arrangement, all of the above-described protection schemes and behaviours, including protection TESI hierarchy, request priority and contention resolution can be extended to apply across two or more protection groups in the network.

If desired, a TESI that is designated as a working TESI in one protection group may be designated as a protection TESI in another protection group. In such cases, the techniques described above can be used, alone or in combination, to mitigate contention issues and limit the risk of “working” traffic of one protection group being pre-empted by protection traffic in the other protection group. For example, the shared TESI operating as a protection TESI can be assigned a protection sequence value of “1” or higher, so that it is less likely to receive protection switched traffic. In addition, pre-emption rules can be defined so that the “working” traffic always has priority over protection switched traffic. Finally, the capacity of the shared TESI may be partitioned between each of the protection groups with which the TESI is associated. If desired, this partitioning may be fixed, so that each partition group is allocated a predetermined proportion of the total capacity of the shared TESI, which remains fixed independently of the bandwidth requirements or priority levels of the traffic flows within each protection group.

The embodiment(s) of the invention described above is(are) intended to be exemplary only. The scope of the invention is therefore intended to be limited solely by the scope of the appended claims.

We claim:

1. A method of controlling traffic forwarding in a Provider Backbone-Traffic Engineered (PBB-TE) network, the method comprising:
defining a protection group including N working Traffic Engineered Service Instances (TESIs) and M protection TESIs, where N≧1 and M≧1; and
providing a Automatic Protection Switching Protocol Data Unit (APS PDU) including information defining at least a state of the protection group; and
forwarding the APS PDU through each protection TESI.

2. The method as claimed in claim 1, wherein M≧2, and wherein the APS PDU further comprises information about a hierarchy of the protection TESIs, the hierarchy defining an order in which traffic can be protection switched to each of the protection TESIs.

3. The method as claimed in claim 1, wherein N≧2, and wherein the APS PDU further comprises information about a priority of a protection switching request, the priority determining whether traffic being protection switched to a given protection TESI can pre-empt traffic already being forwarded through that protection TESI.

4. The method as claimed in claim 3, wherein a respective portion of a capacity of each protection TESI is allocated to each working TESI.

5. The method as claimed in claim 1, wherein at least one TESI is shared between the protection group and another protection group defined in the network.

6. The method as claimed in claim 5, wherein a shared TEST is a working TESI in both protection groups.

7. The method as claimed in claim 5, wherein a shared TEST is a protection TESI in both protection groups.

8. The method as claimed in claim 5, wherein a shared TESI is a working TESI in a first protection group and a protection TESI in a second protection group.

9. The method as claimed in claim 5, wherein a respective portion of a capacity of a shared TESI is allocated to each protection group.
